(19) United States
(12) Patent Application Publication
(10) Pub. No.: US 2014/0337522 A1
(43) Pub. Date: Nov. 13, 2014

(54) Method and Device for Filtering Network Traffic

(71) Applicants: Richard Kuntschke, Geisenhausen (DE); Sebastian Käbisch, Munchen (DE)

(72) Inventors: Richard Kuntschke, Geisenhausen (DE); Sebastian Käbisch, Munchen (DE)

(21) Appl. No.: 14/365,180

(22) PCT Filed: Nov. 8, 2012
(86) PCT No.: PCT/EP2012/072106

§ 371 Date: Jun. 13, 2014

(30) Foreign Application Priority Data
Dec. 13, 2011 (EP) EP 11193303.2
Mar. 7, 2012 (EP) EP 12158419.7

(51) Int. Cl. H04L 12/58

(52) U.S. Cl. CPC H04L 51/12
USPC 709/224

(57) ABSTRACT

The invention relates to a method for filtering network data in a network node, comprising the steps of producing filter markings in a grammatical structure of network data encoded by means of an encoding scheme on the basis of adjustable filter inquiries of at least one further network node, producing a filter mask on the basis of the filter markings, receiving a data flow encoded by means of the encoding scheme in the network node, filtering the data flow by means of the filter mask, and forwarding the filtered encoded data flow to the at least one further network node.

This application is the National Stage of International Application No. PCT/EP2012/072106, filed Nov. 8, 2012, which claims the benefit of European Patent Application No. EP 11193303.2, filed Dec. 13, 2011, and European Patent Application No. EP 12158419.7, filed Mar. 7, 2012. The entire contents of these documents are hereby incorporated herein by reference.

### BACKGROUND

The present embodiments relate to a method and a device for filtering network traffic (e.g., for filtering coded XML data streams in network nodes with limited resources).

Wireless or wired sensor networks are nowadays connected to the Internet in order to make it possible to control the sensors in the sensor network from all over the world via the Internet. In order to connect network nodes in a sensor network to one another or to other networks (e.g., to the Internet), corresponding interfaces are used to transmit control commands, data packets and/or messages.

Networks are relying more and more on universal data transmission protocols that exist in standardized form and may be interpreted in all networks. Since use is increasingly being made of Web services (e.g., often using standardized network protocols such as Simple Object Access Protocol (SOAP)) for communication, it is advantageous to use communication protocols that are compatible with these network protocols. SOAP is a protocol for interchanging messages via a computer network and establishes rules for message design. For example, SOAP controls how data may be represented and interpreted in the message. SOAP is based on a uniform structured markup language such as Extensible Markup Language (XML).

Although the verbosity and plethora of data of such network protocols may be easily handled by systems having a high computational power such as PCs, laptops or mobile telephones, this quantity of data may be managed by embedded devices or systems (“embedded devices”) such as, for example, microcontrollers that may be used in sensor networks, only with considerable runtime losses and a large storage requirement. These storage capacities may not be achieved in embedded devices.

Therefore, for use in networks with embedded devices, coding protocols (e.g., Efficient XML Interchange, W3C standard (EXI) or Binary MPEG format for XML, standardized according to ISO/IEC 23001-1 (BiM)), with the aid of which data from verbose network protocols such as XML may be coded in compressed form, may be used. EXI and BiM are binary coding schemes of text-based XML documents.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method for filtering network data in a network node includes producing filter markings in a grammatical structure of network data coded using a coding scheme based on adjustable filter queries from at least one further network node, producing a filter mask based on the filter markings, receiving a data stream coded using the coding scheme in the network node, filtering the data stream with the aid of the filter mask, and forwarding the filtered coded data stream to the at least one further network node.

According to another aspect, a device for filtering network data in a network node is provided. The device includes a configuration device that is designed to receive adjustable filter queries from at least one further network node, and a marking device configured to produce filter markings in a grammatical structure of network data coded using a coding scheme based on the adjustable filter queries. The device also includes a mask device configured to produce a filter mask based on the filter markings, and a filter device configured to filter a data stream received by the network node and coded using the coding scheme with the aid of the filter mask. The filter is also configured to forward the filtered coded data stream to the at least one further network node. The device may be, for example, a microprocessor of an embedded system.

According to another aspect, a network node including a device according to one or more of the present embodiments is provided. The network node also includes a receiving interface configured to receive a data stream coded using the coding scheme and to guide the data stream through the filter device, and a transmitting interface configured to forward the coded data stream filtered by the filter device to at least one further network node. In this case, the network node may be an embedded system, for example.

A filter query may be carried out on coded network data in a network node without the network data having to be decoded and coded again. This makes it possible to process coded network data (e.g., network data that is present in non-coded form according to verbose communication protocols such as XML) in a quick, efficient and resource-saving manner. This makes it possible to considerably reduce the network traffic. In addition, one or more of the present embodiments may be applied to embedded systems and devices that receive and transmit network data.

According to one embodiment, the data stream may have XML format. In this case, the coding scheme may include a binary XML coding scheme. The filter queries may advantageously have XPath filter queries or XQuery filter queries.

This makes it possible to process binary-coded XML data streams in a resource-saving manner in network nodes with a low storage capacity (e.g., in embedded systems or sensor network nodes).

### BRIEF DESCRIPTION OF THE DRAWINGS

FIG. 1 shows a network having a plurality of network nodes according to one embodiment;

FIG. 2 shows a schematic illustration of an exemplary grammatical structure for coded network data according to another embodiment;

FIG. 3 shows a schematic illustration of the grammatical structure for coded network data in FIG. 2 having filter markings according to another embodiment;

FIG. 4 shows a schematic illustration of a filter grammatical structure for coded network data according to another embodiment;

FIG. 5 shows a schematic illustration of a filter grammatical structure for coded network data according to another embodiment; and

FIG. 6 shows a schematic illustration of a network node according to another embodiment; and

FIG. 7 shows a schematic illustration of a method for filtering network traffic according to another embodiment.

The same and/or elements acting the same in the figures are provided with the same reference symbols. The illustrations indicated are not necessarily indicated in a manner true to scale. Individual features and/or concepts of different embodiments illustrated in the drawings may be combined with one another in any desired manner, if useful.

### DETAILED DESCRIPTION

Coding schemes in the sense of the present embodiments include all protocols that are suitable for coding network data (e.g., XML data) in a compressed form that may be decoded on a one-to-one basis. In this case, coding schemes may include, for example, Efficient XML Interchange (EXI), Binary MPEG format for XML (BiM), Wireless Binary XML (WBXML), Extensible Binary Meta Language (EBML), FastInfoset, ASN.1, XGrind or XQueC.

FIG. 1 shows a schematic illustration of a network 100 having a plurality of network nodes 101 to 108 that are coupled to one another via network connections. The network 100 may be, for example, a sensor network that networks embedded systems to one another. In such a sensor network, sensor data may be interchanged, for example, between the network nodes in XML format. For example, the network nodes 104, 105 and 107 may be subscribers of network data that is generated or received in the network node 101. In order to make it possible to efficiently process network data in the network 100, it is advantageous for the network node 101 to already select or filter the network data to be distributed to the network nodes 104, 105 and 107 in the network 100.

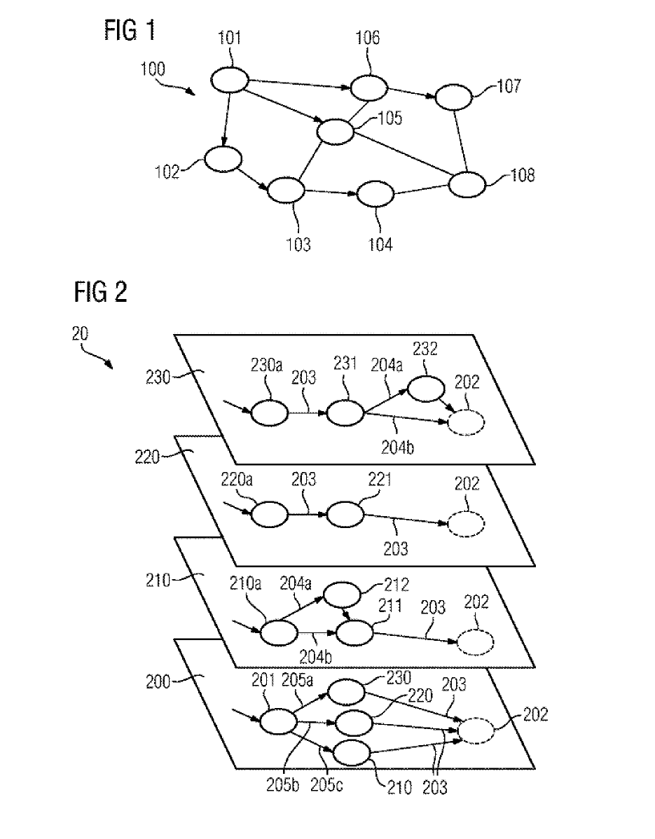

The network data may be transmitted, for example, in binary coded form in the network 100. FIG. 2 shows a schematic illustration of an exemplary grammatical structure 20 for coded network data that may be transmitted in the network 100. By way of example, reference is made below to EXI as the coding scheme, but any other coding scheme (e.g., for XML data) is likewise suitable.

At a root level 200, the grammatical structure 20 includes an access node 201 that points to three substates 210, 220 and 230 via 2-bit transitions 205a, 205b and 205c. For each of the substates 210, 220, 230, the grammatical structure has a subordinate hierarchical level in which the respective deterministic finite automata represent a complex type in an XML scheme. For example, the substate 210 may represent an automaton that codes a complex type “A”.

The access node 210a of the substate 210 leads, via 1-bit transitions 204a, 204b, to two substates 211, 212 of the substate 210 that are subtypes of the type coded by the substate 210. For example, the substate 211 may code the complex subtype “d”, where the substate 212 may code the complex subtype “e”. In the example in FIG. 2, the substate 212 again leads back to the substate 211, from which a zero transition 203 points to the exit node 202 of the sub state 210.

The substates 220 and 230 (e.g., type “B” and type “C”) each having access nodes 220a and 230a and substates 221 (e.g., subtype “f”), 231 (e.g., subtype “g”) and 232 (e.g., subtype “h”) are coded in a similar manner. These are each linked to one another via 1-bit transitions 204a, 204b or zero transitions 203 and each lead back to the exit node 202 of the respective substate 220 or 230.

An exemplary EXI data stream E1 for the substate 210 may therefore be E1=00 1 “e” “d”, in which case the substate 210 is represented by the 2-bit operator “00”, the 1-bit transition within the substate 210 is represented by the 1-bit operator 1, and the two substates 211 and 212 available in the substate 210 are represented by the respective contents “d” and “e”. In this respect, it is noted that the 1-bit operator 0 may be omitted before the substate 211 for compression reasons.

Filter queries that may be in the XPath format or XQuery format, for example, may be applied to the EXI data streams constructed in this manner. XPath is a query syntax that is standardized in W3C and may be used to address types or subtypes of data in XML format. Based on these filter queries, the grammatical structure 20 may be converted into a marked grammatical structure in which the types and subtypes relevant to the filter query are respectively marked.

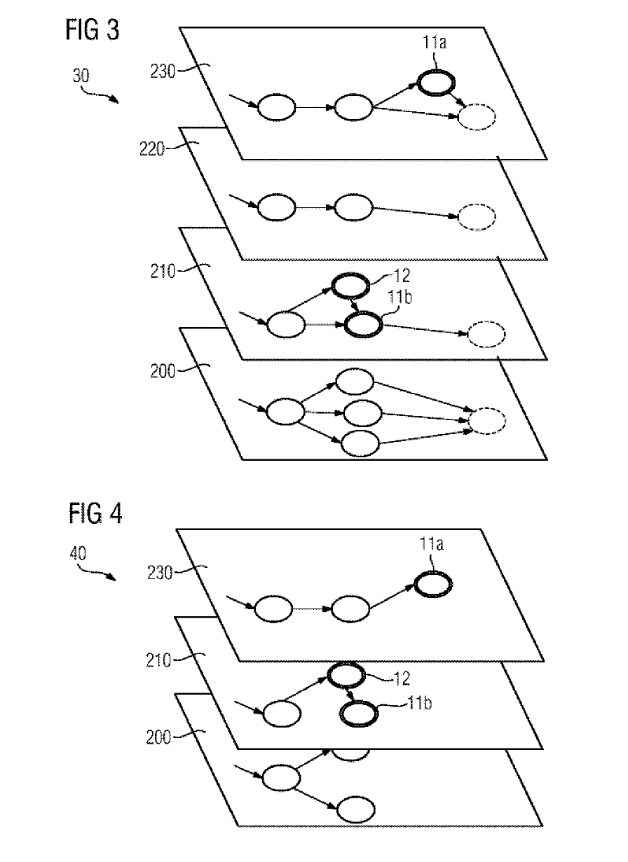

FIG. 3 shows a schematic illustration of an exemplary grammatical structure 20 for coded network data from FIG. 2 with corresponding filter markings. This marked grammatical structure 30 is shown, by way of example, for a filter query according to the XPath format with the query parameters “/C/h”, “/A[e]/d” and “//h”. The query parameter “/C/h” filters all types “C” having a subtype “h”, the query parameter “//h” filters all subtypes “h” whatever the type, and the query parameter “/A[e]/d” filters all subtypes “d” contained in a type “A”, provided that the type “A” also includes a subtype “e”.

In this manner, the marked grammatical structure 30 includes filter markings 11 that indicate substates according to the query. In contrast, the filter markings 12 indicate substates that are used as conditional substates for one of the filter queries.

As shown by way of example in FIG. 4 for the marked grammatical structure 30 from FIG. 3, a filter mask 40 may be generated from the marked grammatical structure 30. The filter mask includes only the substates indicated by one of the filter markings 11a, 11b and 12. This filter mask 40 may be applied to the incoming data streams in a network node. The grammatical structure 20 of the data streams is to be known for this purpose. For all XML data coded using a predefined coding scheme (e.g., EXI), network data may be filtered with the aid of the filter mask 40 without the need for decoding to XML format.

In this case, as shown in FIG. 4, the filter mask 40 may also be produced outside the network node since the production of the filter grammar and the actual filtering relate to logically separate processes that do not necessarily have to be embedded in a common process sequence. For example, a central point may be provided in the network 100 for the purpose of producing the filter masks 40 that may then be distributed to the respective network nodes 101 to 108 in order to filter network traffic with the aid of the filter mask 40.

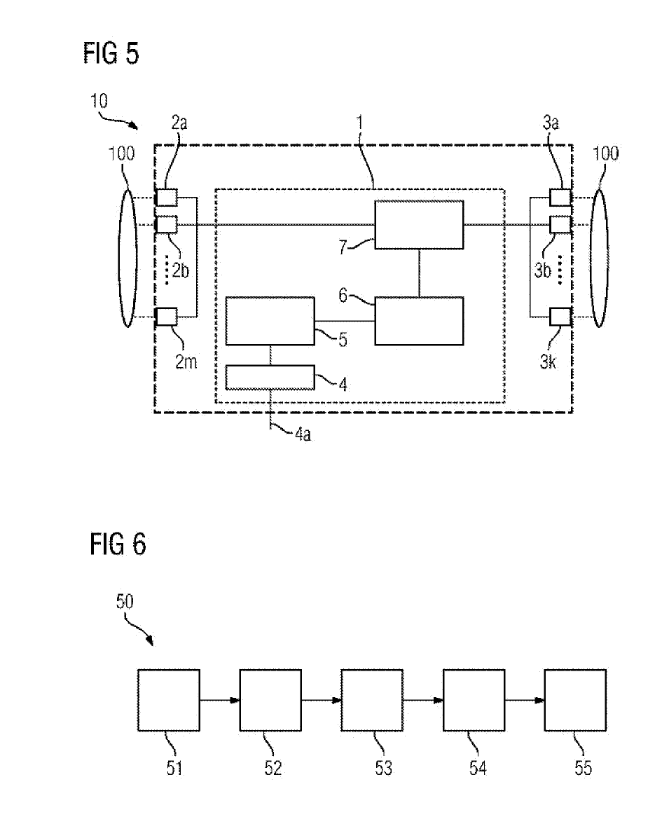

FIG. 5 shows a schematic illustration of one embodiment of a network node 10 having a device 1 for filtering network data. In this case, the network node 10 may be incorporated, for example, in a network 100, as shown in FIG. 1. For example, one or more of the network nodes 101 to 108 shown may have the structure of the network node 10 shown in FIG. 5.

The network node 10 includes a receiving interface with receiving ports 2a, 2b, 2m at which network traffic from the network 100 may be received. The receiving interface may be configured to receive a data stream coded using a coding scheme and may be configured to guide the data stream through a filter device 7. In this case, the coded data stream may have, for example, a binary XML format (e.g., EXI or BiM data). The network node 10 also includes a transmitting interface with transmitting ports 3a, 3b, 3k configured to forward the coded data stream filtered by the filter device 7 to the network 100 and, for example, to at least one further network node 101 to 108. In this case, the filtered coded data stream may be transmitted to the network nodes that have addressed corresponding filter queries 4a to the network node 10.

The network node 10 may have, for example, an embedded system having an ARM microprocessor as the device 1. Such microprocessors may be configured in a microcontroller and may have several kB of rewritable memory (RAM memory) and several kB of flash memory. The network node 10 may also be operated using an operating system of the microcontroller (e.g., ContikiOS or Java Micro Edition CDLC). Communication via the interfaces of the network node 10 may be undertaken, for example, using IPv6 over Low Power Wireless Personal Area Networks (6LoWPAN).

The device 1 includes a configuration device 4, a marking device 5 coupled to the configuration device 4, a mask device 6 coupled to the marking device 5, and the filter device 7 coupled to the mask device 6. In this case, the filter device 7 is connected between the receiving interface and the transmitting interface of the network node 10 in order to forward the filtered coded data stream to the network 100.

The configuration device 4 is configured to receive adjustable filter queries 4a from at least one further network node. These filter queries 4a may include, for example, XPath filter queries or XQuery filter queries and may include information indicating which type of data the respective querying network node would or would not like to receive. For example, the network node 10 may be a sensor network node that receives or generates sensor data. Other network nodes may be interested in receiving these sensor data if particular sensor parameters are within predefined ranges. For example, a network node may wish to receive sensor data from a temperature sensor only when a critical temperature value is exceeded. In this case, a filter query 4a that filters the network data according to sensor data in which a data entry for temperature data exceeds the critical temperature value may be created.

The marking device 5 receives the filter queries 4a from the configuration device 4 and is configured to produce filter markings 11, 12 in a grammatical structure 20 of network data coded using a coding scheme based on the filter queries 4a (e.g., as explained in connection with FIGS. 2 and 3). In this case, the grammatical structure 20 of all possible data accruing in the network node 10 is stored in the marking device 5. If the data format of the incoming data streams changes (e.g., because data fields in XML format are changed, added or deleted), the grammatical structure 20 in the marking device 5 may be accordingly updated. The mask device 6 is configured to produce a filter mask 40 based on the filter markings 11, 12, for example, as explained in connection with FIG. 4.

The filter mask 40 produced in this manner is then used by the filter device 7 to filter the data stream that is coded using the coding scheme and is passed through the filter device 7 from the receiving interface of the network node 10. In this case, the filter device 7 may selectively forward network data to particular network nodes depending on whether or not their filter queries 4a, on which the respective filter mask 40 is based, apply to the respective network data. The network data that does not pass through the filter mask 40 may be rejected by the filter device 7.

FIG. 6 shows a schematic illustration of one embodiment of a method 50 for filtering network traffic. The method 50 may be used, for example, in the network 100 shown in FIG. 1 and may be used, for example, to operate a network node 10, as shown in FIG. 5.

In act 51, filter markings are produced in a grammatical structure of network data coded using a coding scheme based on adjustable filter queries from at least one further network node (e.g., one of the network nodes 101 to 108 in the network 100 from FIG. 1). In act 52, a filter mask is produced based on the filter markings.

A data stream that is coded using the coding scheme is received in the network node in act 53. This data stream may be filtered, in act 54, with the aid of the filter mask (e.g., in the filter device 7 of the network node 10). After filtering, the filtered coded data stream may be forwarded to the at least one further network node in act 55.

The advantages when using binary XML formats as coding schemes are the high compression rate and the associated bandwidth saving when transmitting the coded network data, and the correspondingly low storage requirement in the respective network nodes. These advantages may be retained with the aid of the method 50 and the device 1 in the network node 10 since decoding to XML format does not become necessary at any time when processing the coded data stream in the network node 10.

Instead, the network data may be analyzed and filtered in coded form. This is advantageous, for example, for embedded systems or other network nodes with limited resources such as memory or computational capacity since complicated decoding and coding of the network data may be dispensed with again. The procedure according to one or more of the present embodiments is also advantageous for network nodes having limited energy resources (e.g., battery-powered sensors), since the computational operations for decoding and coding again do not have to be carried out, and storage operations for extensive XML data are absent.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for filtering network data in a network node, the method comprising:
producing filter markings in a grammatical structure of network data coded using a coding scheme based on adjustable filter queries from at least one further network node;
producing a filter mask based on the filter markings;
receiving a data stream coded using the coding scheme in the network node;
filtering the data stream with the aid of the filter mask; and
forwarding the filtered coded data stream to the at least one further network node.

2. The method of claim 1, wherein the data stream has an XML format.

3. The method of claim 2, wherein the coding scheme comprises a binary XML coding scheme.

4. The method of claim 3, wherein the filter queries include XPath filter queries or XQuery filter queries.

5. A device for filtering network data in a network node, the device comprising:
a configuration device configured to receive adjustable filter queries from at least one further network node;
a marking device configured to produce filter markings in a grammatical structure of network data coded using a coding scheme based on the adjustable filter queries;
a mask device configured to produce a filter mask based on the filter markings; and
a filter device configured to filter a data stream received by the network node and coded using the coding scheme with the aid of the filter mask and to forward the filtered coded data stream to the at least one further network node.

6. The device of claim 5, wherein the data stream has an XML format.

7. The device of claim 6, wherein the coding scheme comprises a binary XML coding scheme.

8. The device of claim 7, wherein the filter queries comprise XPath filter queries or XQuery filter queries.

9. A network node comprising:
a device for filtering network data in a network node, the device comprising:
a configuration device configured to receive adjustable filter queries from at least one further network node;
a marking device configured to produce filter markings in a grammatical structure of network data coded using a coding scheme based on the adjustable filter queries;
a mask device configured to produce a filter mask based on the filter markings; and
a filter device configured to filter a data stream received by the network node and coded using the coding scheme with the aid of the filter mask and to forward the filtered coded data stream to the at least one further network node;
a receiving interface configured to receive a data stream coded using the coding scheme and to guide the data stream through the filter device; and
a transmitting interface configured to forward the coded data stream filtered by the filter device to at least one further network node.

10. The network node of claim 9, wherein the network node comprises an embedded system, and the device is configured in a microprocessor of the embedded system.

11. The network node of claim 9, wherein the data stream has an XML format.

12. The network node of claim 11, wherein the coding scheme comprises a binary XML coding scheme.

13. The network node of claim 12, wherein the filter queries comprise XPath filter queries or XQuery filter queries.
